(19) United States
(12) Patent Application Publication
(10) Pub. No.: US 2014/0026116 A1
(43) Pub. Date: Jan. 23, 2014

(54) SOURCE CONTROL EXECUTION PATH LOCKING

(71) Applicants: Albert A. DeLucca, Wantagh, NY (US); Lisa Seacat DeLuca, San Francisco, CA (US); Soobaek Jang, Hamden, CT (US); Troy Machael Volin, Chapel Hill, NC (US)

(72) Inventors: Albert A. DeLucca, Wantagh, NY (US); Lisa Seacat DeLuca, San Francisco, CA (US); Soobaek Jang, Hamden, CT (US); Troy Machael Volin, Chapel Hill, NC (US)

(73) Assignee: International Business Machines Corporation, Armonk, NY (US)

(21) Appl. No.: 13/552,630

(22) Filed: Jul. 18, 2012

(51) Int. Cl. G06F 9/44

(52) U.S. Cl. 717/120

(57) ABSTRACT

An embodiment of the invention provides a method for source control in a computer program, wherein the computer program includes a plurality of files for execution of a plurality of processes. A revised process that is selected by a user on a graphical user interface is identified, wherein the revised process includes an execution path. A revised portion of a file in the revised process that the user is revising, has revised, and/or is planning on revising is identified. Portions of files that are in the execution path of the revised process are identified. The portions of the files in the execution path of the revised process are locked with a source control processor. The locking disallows revisions (e.g., write and delete operations) to the portions of the files in the execution path of the revised process that are not made by the user.

### BACKGROUND

The present invention is in the field of methods and computer program products for source control execution path locking

Source code (commonly just source or code) is any sequence of statements and/or declarations written in some human-readable computer programming language. Programming languages are artificial languages that can be used to control the behavior of a machine, particularly a computer. More specifically, a programming language is used to write computer programs, which instruct a computer to perform some kind of computation, and possibly control external devices.

To ensure that a computer program is complete, precise and accurate, software development projects often employ hundreds of software developers to write and edit the program code. In such cases, it is common for multiple software developers to work on a program code at the same time such as, for example, editing different or the same sections of the program code.

### SUMMARY OF THE INVENTION

An embodiment of the invention provides a method for source control in a computer program, wherein the computer program includes a plurality of files for execution of a plurality of processes. A revised process that is selected by a user on a graphical user interface is identified, wherein the revised process includes an execution path. A revised portion of a file in the revised process that the user is revising, has revised, and/or is planning on revising is identified.

Portions of files that are in the execution path of the revised process are identified. This includes identifying all nodes above the revised portion of the file in an execution tree of the revised process, and identifying all nodes below the revised portion of the file in the execution tree of the revised process. The portions of the files in the execution path of the revised process are locked with a source control processor. The locking disallows revisions (e.g., write and delete operations) to the portions of the files in the execution path of the revised process that are not made by the user.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method for source control execution path locking according to an embodiment of the invention;

FIG. 2 illustrates a source code according to an embodiment of the invention;

FIG. 3 is a flow diagram illustrating a method for source control in a computer program according to an embodiment of the invention;

FIG. 4 illustrates a computer program according to an embodiment of the invention; and

FIG. 5 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides a method for execution path locking In software application development, agile software development (ASD) is a method for the creative process that anticipates the need for flexibility and applies a level of pragmatism into the delivery of the finished product. As is common in ASD, source code is developed on a function by function basis. In many cases, delivering a particular function touches many smaller units of many files. Building on the idea of method level locking, a computer programmer (also referred to herein as a “user”) can select a method (also referred to herein as a “process”) as a starting point, and lock all methods in the execution paths across file boundaries. This allows for computer programmers to code a given function without unintended side effects being introduced by changes to downstream methods.

In at least one embodiment of the invention, locking can be initiated at any level in the execution path, and the locking will extend to the leaf node. Thus, any referenced constant members within the locked method invocations will also be locked. The locking applies to both procedural and object oriented languages.

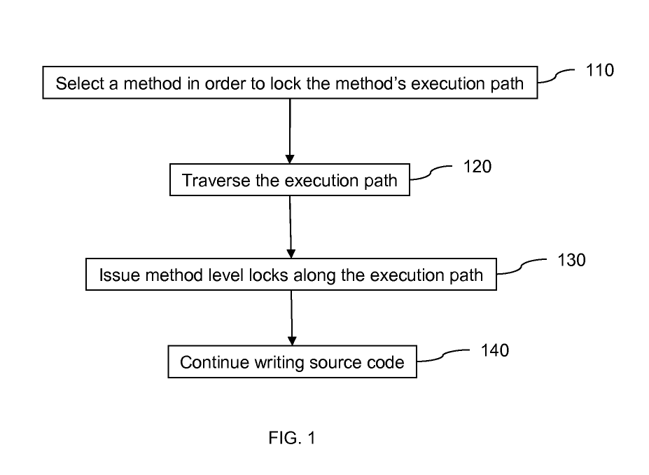

FIG. 1 is a flow diagram illustrating a method for source control execution path locking according to an embodiment of the invention. A computer programmer selects a method in order to lock the method's execution path 110. The method can be selected via a contextual menu or some other input mechanism in the programmer's source editor.

The execution path is traversed, starting at the selected source method and visiting all nodes in the given execution tree 120. The execution path is traversed until a [set of] self contained leaf method(s) are reached. Method level locks are issued along the execution path 130. In another embodiment, class level locks are issued on all classes visited in the execution tree.

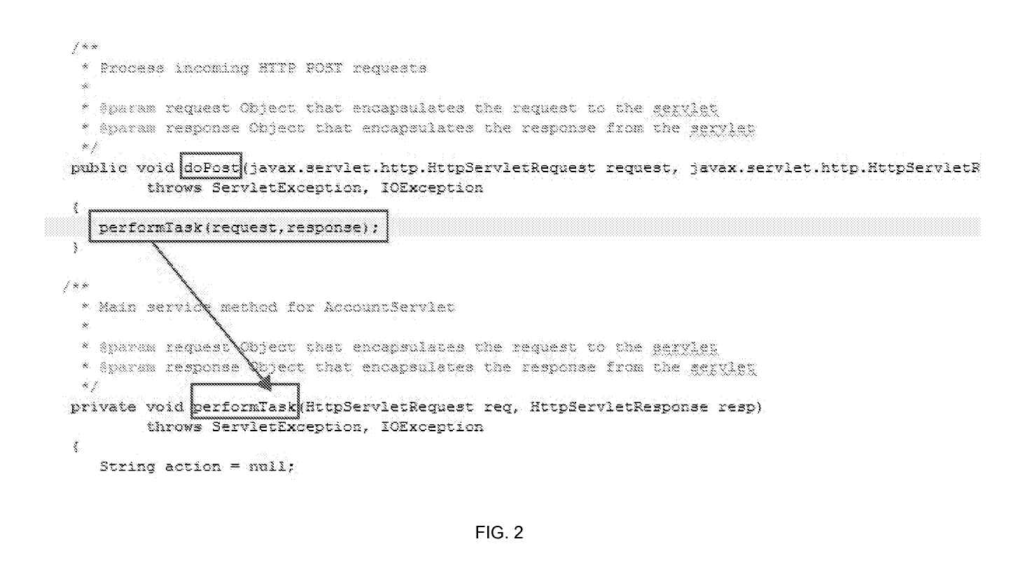

Programmers can now continue to write source code 140 knowing that nothing else will be changed in the downstream execution path. Therefore, the changes made by the programmer will be functional when the code changeset is delivered for source code integration. For example, in the source code illustrated in FIG. 2, the “doPost” method is locked by the programmer. Because the “performTask” method is in the execution path of the “doPost” method, the “performTask” method is automatically locked.

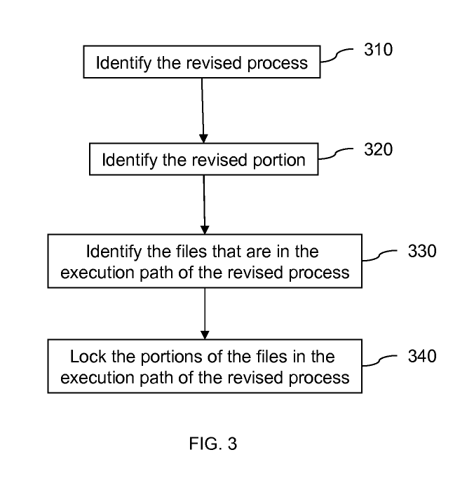

FIG. 3 is a flow diagram illustrating a method for source control in a computer program according to an embodiment of the invention. The computer program includes a plurality of files, which execute a plurality of processes. A process to be revised (referred to herein as the “revised process”) is selected by a user on a graphical user interface. The revised process is identified 310, wherein the revised process includes an execution path within the computer program.

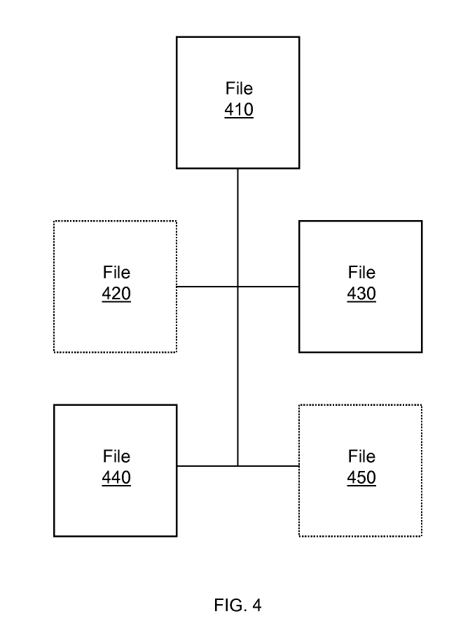

In at least one embodiment of the invention, the revised process includes portions of files in multiple files in the computer program. For example, as illustrated in FIG. 4, a computer program includes files 410, 420, 430, 440, and 450; and, the revised process include portions of files 410, 430, and 440. The portion of the file that the user is revising, has revised, and/or is planning on revising (referred to herein as the “revised portion”) is identified 320. Thus, in the example, if the user is currently revising file 430, then the portion of file 430 that the user is revising is identified as the “revised portion”.

Files that are in the execution path of the revised process are identified 330. More specifically, all of the nodes (file portions) above the revised portion of the file in the execution tree of the revised process are identified. Similarly, all of the nodes below the revised portion of the file in the execution tree of the revised process are identified. The portions of the files in the execution path of the revised process include the revised portion and the identified nodes above and below the revised portion.

In the example above, nodes in file 410 are identified as being above the revised portion (i.e., file 430) in the execution tree; and, nodes in file 440 are identified as being below the revised portion in the execution tree. Files 420 and 450 are not in the execution path of the revised process. In at least one embodiment of the invention, the portions of the files in the execution path are identified with a computer hardware processor.

The portions of the files in the execution path of the revised process are locked with a source control processor 340. Thus, revisions (e.g., write and delete operations) that are not made by the user are not allowed to the portions of the files that are in the execution path of the revised process. In other words, the user has exclusive write access to the portions of the files in the execution path of the revised process.

The source control processor locks nodes above the revised portion and nodes below the revised portion. Thus, in the example, nodes in files 410, 430, and 440 are locked. In at least one embodiment of the invention, the source control processor is a computer hardware component connected to the processor that locks the portions of the files in the execution path of the revised process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

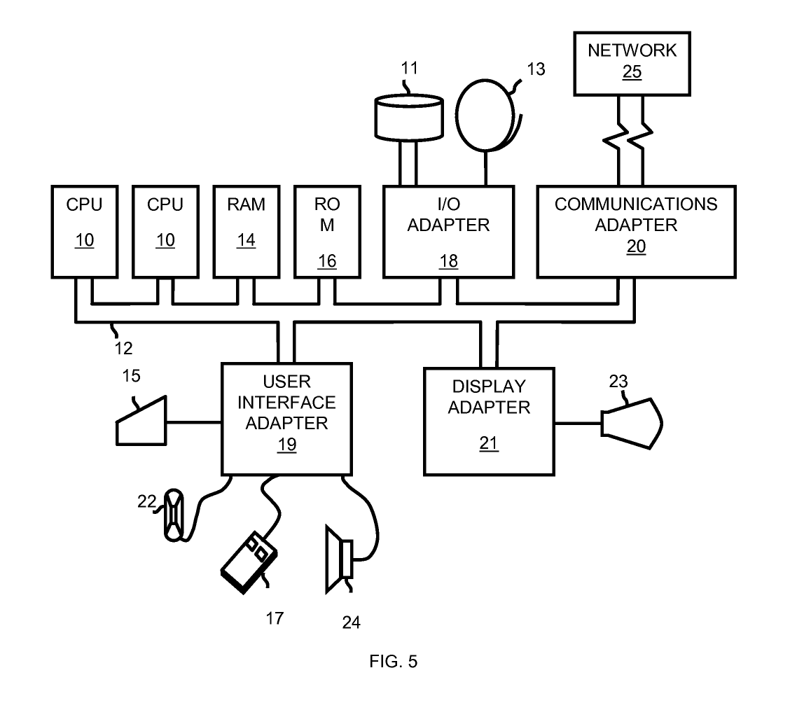

Referring now to FIG. 5, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for source control in a program, the program comprising a plurality of files for execution of a plurality of processes, said method comprising:
identifying a revised process selected by a user on a graphical user interface, the revised process including an execution path;
identifying portions of files that are in the execution path of the revised process with a processor; and
locking the portions of the files in the execution path of the revised process with a source control processor, said locking including disallowing revisions to the portions of the files in the execution path of the revised process that are not made by the user.

2. The method according to claim 1, further comprising identifying a revised portion of a file in the revised process that the user is at least one of revising, has revised, and is planning on revising,
wherein said identifying of the portions of the files that are in the execution path of the revised process includes:
identifying all nodes above the revised portion of the file in an execution tree of the revised process, and
identifying all nodes below the revised portion of the file in the execution tree of the revised process.

3. The method according to claim 2, wherein the nodes above the revised portion and the nodes below the revised portion comprise the portions of the files in the execution path of the revised process.

4. The method according to claim 2, wherein said locking of the portions of the files includes locking the nodes above the revised portion.

5. The method according to claim 2, wherein said locking of the portions of the files includes locking the nodes below the revised portion.

6. The method according to claim 1, wherein the revised process includes portions of files in multiple files in the program.

7. The method according to claim 3, wherein said locking of the portions of the files includes:
locking the nodes above the revised portion; and
locking the nodes below the revised portion.

8. The method according to claim 3, wherein the revised process includes portions of files in multiple files in the program.

9. A method for source control in a computer program, the computer program comprising a plurality of files for execution of a plurality of processes, said method comprising:
identifying a revised process selected by a user on a graphical user interface, the revised process including an execution path;
identifying a revised portion of a file in the revised process that the user is at least one of revising, has revised, and is planning on revising;
identifying portions of files that are in the execution path of the revised process with a processor, said identifying of the portions of the files that are in the execution path of the revised process including:
identifying all nodes above the revised portion of the file in an execution tree of the revised process, and
identifying all nodes below the revised portion of the file in the execution tree of the revised process,
the nodes above the revised portion and the nodes below the revised portion comprise the portions of the files in the execution path of the revised process; and
locking the portions of the files in the execution path of the revised process with a source control processor, said locking including disallowing write and delete operations to the portions of the files in the execution path of the revised process that are not made by the user.

10. The method according to claim 9, wherein said locking of the portions of the files includes locking the nodes above the revised portion.

11. The method according to claim 9, wherein said locking of the portions of the files includes locking the nodes below the revised portion.

12. The method according to claim 9, wherein the revised process includes portions of files in multiple files in the computer program.

13. The method according to claim 12, wherein said locking of the portions of the files includes locking the nodes above the revised portion.

14. The method according to claim 12, wherein said locking of the portions of the files includes locking the nodes below the revised portion.

15. A computer program product for source control in a program, the program comprising a plurality of files for execution of a plurality of processes, said computer program product comprising:
a computer readable storage medium;
first program instructions to identify a revised process selected by a user, the revised process including an execution path;
second program instructions to identify portions of files that are in the execution path of the revised process; and
third program instructions to lock the portions of the files in the execution path of the revised process, said locking including disallowing revisions to the portions of the files in the execution path of the revised process that are not made by the user,
said first program instructions, said second program instructions, and said third program instructions are stored on said computer readable storage medium.

16. The computer program product according to claim 15, further comprising fourth program instructions to identify a revised portion of a file in the revised process that the user is at least one of revising, has revised, and is planning on revising,
wherein said second program instructions:
identifies all nodes above the revised portion of the file in an execution tree of the revised process, and
identifies all nodes below the revised portion of the file in the execution tree of the revised process.

17. The computer program product according to claim 13, wherein the nodes above the revised portion and the nodes below the revised portion comprise the portions of the files in the execution path of the revised process.

18. The computer program product according to claim 13, wherein said third program instructions lock the nodes above the revised portion.

19. The computer program product according to claim 13, wherein said third program instructions lock the nodes below the revised portion.

20. The computer program product according to claim 15, wherein the revised process includes portions of files in multiple files in the program.
